(19) United States
(12) Patent Application Publication
(10) Pub. No.: US 2024/0064392 A1
(43) Pub. Date: Feb. 22, 2024

(54) MULTI-BAND IMAGE CAPTURING APPARATUS AND METHOD

(71) Applicant: KYUNGPOOK NATIONAL UNIVERSITY INDUSTRY-ACADEMIC COOPERATION FOUNDATION, Daegu (KR)

(72) Inventors: Sung Hak LEE, Daegu (KR); Sun Gon JUN, Busan (KR)

(73) Assignee: KYUNGPOOK NATIONAL UNIVERSITY INDUSTRY-ACADEMIC COOPERATION FOUNDATION, Daegu (KR)

(21) Appl. No.: 18/269,715

(22) PCT Filed: Nov. 15, 2021
(86) PCT No.: PCT/KR2021/016618

§ 371 Date: Jun. 26, 2023

(51) Int. Cl. H04N 23/11; H04N 23/12; H04N 23/55; H04N 23/74

(52) U.S. Cl. CPC H04N 23/11; H04N 23/12; H04N 23/55; H04N 23/74

(57) ABSTRACT

The present invention relates to a multi-band image capturing apparatus and method for capturing multi-band images, including visible and infrared images, by using a light adjustment filter, the apparatus comprising: a camera unit for acquiring multi-band images including visible and infrared images; a lighting unit for emitting infrared rays; an optical filter unit which includes a hot mirror filter region and an infrared transmission filter region, and which selectively transmits visible light therethrough by moving and arranging the hot mirror filter region onto an optical path or transmits infrared rays therethrough by moving and arranging the infrared transmission filter region onto the optical path; and a light adjustment control unit for controlling the camera unit, the lighting unit and the optical filter unit, wherein the light adjustment control unit determines a light level on the basis of the light intensity of infrared rays in an photography environment so as to control the lighting unit so that infrared rays corresponding to the determined light level are emitted, and control the optical filter unit so that the hot mirror filter region or the infrared transmitting filter region is moved and arranged onto the optical path in correspondence to a light wavelength band image to be acquired by the camera unit.

### TECHNICAL FIELD

The present disclosure relates to a multi-band image photographing apparatus, and more particularly to a multi-band image photographing apparatus and method for photographing multi-band images including visible light and infrared images using a light adjustment filter.

### BACKGROUND ART

In general, a camera blocks an infrared signal using a hot mirror filter so as to photograph a visible light image.

Incoming infrared light distorts color information, and since an amount of light is particularly strong during the day, infrared light can easily saturate an image.

However, since an infrared image includes detailed information that is not expressed by the visible light image, the visibility of the image can be improved through an information fusion method.

In particular, when there is fog or haze, clear results can be obtained from the infrared image because infrared light has a stronger permeability to particles than visible light.

Accordingly, many studies are being conducted to obtain clear images in various environments by acquiring both the visible light image and the infrared image.

As an existing photographing method for acquiring both a visible light image and an infrared image, Korean Patent Application Publication No. 10-2008-0029051 (Apr. 3, 2008) discloses a photographing method using manual or mechanical filter replacement, or using two image sensors corresponding to two light wavelength bands, or using a special color filter array (CFA) pattern in an image sensor, or the like.

However, the existing technology had problems in that the image photographing was complicated and inconvenient because the filters must be replaced manually or mechanically, and hardware configuration was complicated and production cost due to expensive parts increased since an expensive special image sensor or multiple image sensors were used.

Accordingly, it is required to develop a multi-band image photographing apparatus capable of photographing a clear image in various lighting environments by easily and simply acquiring a multi-band image including a visible light image and an infrared image through simple filter adjustment using only one existing cheap sensor.

### DISCLOSURE

### Technical Problem

A technical object to be achieved by an embodiment of the present disclosure is to provide a multi-band image photographing apparatus and method that can photograph a clear image in various lighting environments by easily and simply acquiring and synthesizing a multi-band image including a visible light image, an infrared image, and a broadband image using one general image sensor and one circulation filter or using one general image sensor and a composite filter including a circulation filter and a switching filter.

The technical objects intended to be achieved by the present disclosure are not limited to those that have been described hereinabove merely by way of example, and other technical objects that are not mentioned can be clearly understood from the following descriptions by those skilled in the art, to which the present disclosure pertains.

### Technical Solution

In order to solve the above technical problems, in one aspect of the present disclosure, there is provided a multi-band image photographing apparatus comprising a camera unit configured to acquire multi-band images including a visible light image and an infrared image, a lighting unit configured to emit infrared light, an optical filter unit including an infrared blocking filter area and an infrared transmission filter area, the optical filter unit being configured to selectively transmit visible light by moving and arranging the infrared blocking filter area on an optical path or transmit the infrared light by moving and arranging the infrared transmission filter area on the optical path, and a light adjustment controller configured to control the camera unit, the lighting unit, and the optical filter unit, wherein the light adjustment controller is configured to determine a light level based on an amount of infrared light of a photographing environment and control the lighting unit so that the infrared light corresponding to the determined light level is emitted; and control the optical filter unit to move and arrange the infrared blocking filter area or the infrared transmission filter area on the optical path based on an optical wavelength band image to be acquired by the camera unit.

In another aspect of the present disclosure, there is provided a multi-band image photographing method of a multi-band image photographing apparatus including a camera unit, a lighting unit, an optical filter unit, a light adjustment controller, and an image synthesis unit, the multi-band image photographing method comprising checking, by the light adjustment controller, whether an image photographing request is received, checking, by the light adjustment controller, an amount of infrared light of a photographing environment if the image photographing request is received, determining, by the light adjustment controller, a light level based on the amount of infrared light of the photographing environment and determining whether to emit the infrared light corresponding to the determined light level, emitting, by the lighting unit, the infrared light based on the determined light level, circularly arranging, by the optical filter unit, an infrared blocking filter area or an infrared transmission filter area on an optical path, acquiring, by the camera unit, a visible light image corresponding to a visible light wavelength band if the infrared blocking filter area of the optical filter unit is disposed in front, and acquiring an infrared image corresponding to an infrared wavelength band or a broadband image corresponding to a broadband including the visible light wavelength band and the infrared wavelength band if the infrared transmission filter area of the optical filter unit is disposed in front, and synthesizing, by the image synthesis unit, at least two images based on the acquired visible light image, infrared image, and broadband image.

### Advantageous Effects

Effects of a multi-band image photographing apparatus and method according to the present disclosure are described as follows.

The present disclosure can easily and simply acquire a multi-band image including a visible light image, an infrared image, and a broadband image by using one general image sensor and one circulation filter or using one general image sensor and a composite filter including a circulation filter and a switching filter, and can implement image synthesis capable of visually identifying and recognizing objects in various lighting environments.

Additional scope of applicability of the present disclosure will become apparent from the detailed description given blow. However, it should be understood that the detailed description and specific examples such as embodiments of the present disclosure are given merely by way of example, since various changes and modifications within the spirit and scope of the present disclosure will become apparent to those skilled in the art from the detailed description.

### DESCRIPTION OF DRAWINGS

FIG. 1 is a block configuration diagram illustrating a multi-band image photographing apparatus according to a first embodiment of the present disclosure.

FIG. 2 illustrates a drive of an optical filter unit of FIG. 1.

FIG. 3 is a block configuration diagram illustrating a multi-band image photographing apparatus according to a second embodiment of the present disclosure.

FIG. 4 illustrates a drive of an optical filter unit of FIG. 3.

### MODE FOR INVENTION

Reference will now be made in detail to embodiments of the disclosure, examples of which are illustrated in the accompanying drawings.

A suffix such as “module” and “unit” for the component used in the following description is merely intended to facilitate description of the present disclosure, and the suffixes “module” and “unit” may be mixed and used.

Furthermore, embodiments of the present disclosure will be described in detail with reference to the accompanying drawings and the descriptions of the accompanying drawings, but the present disclosure is not limited or restricted by the embodiments.

Terms used in the present disclosure has been chosen as currently widely used general terms as possible while considering its function in the present disclosure, but may vary depending on the intention or custom of a person skilled in the art or the emergence of new technology. In certain cases, there are also terms arbitrarily selected by the applicant, and in this case, the meaning will be described in the description of the relevant invention. Accordingly, it is intended to clarify that terms used in the present disclosure should be interpreted based on the actual meaning of terms and the contents throughout the present disclosure, rather than the names of simple terms.

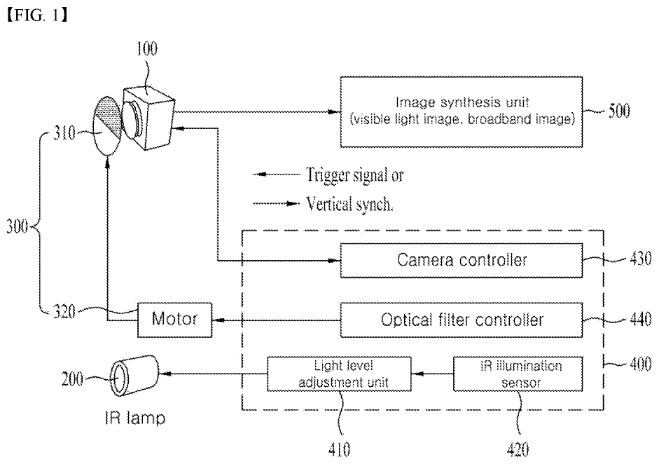

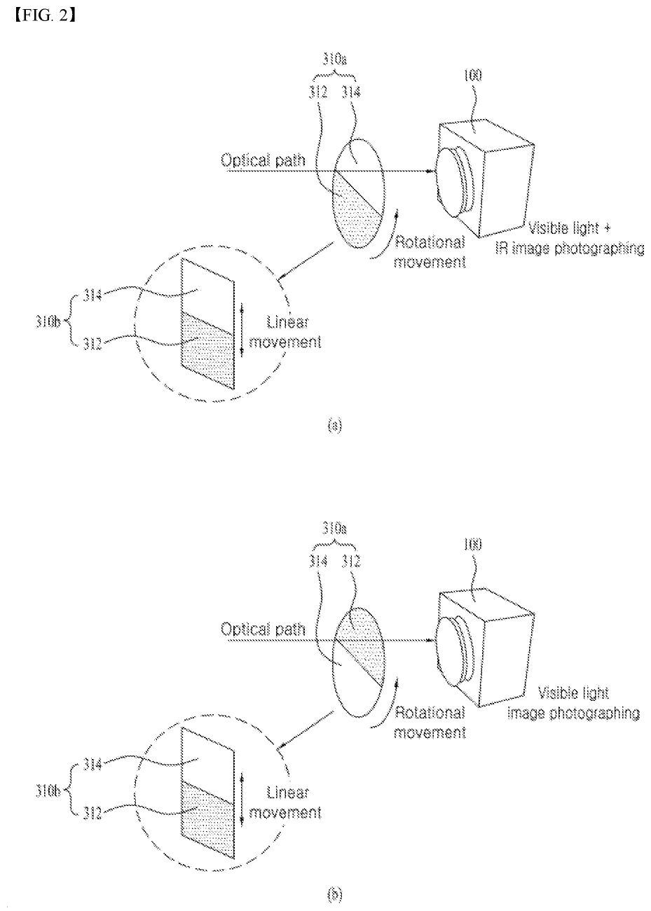

FIG. 1 is a block configuration diagram illustrating a multi-band image photographing apparatus according to a first embodiment of the present disclosure. FIG. 2 illustrates a drive of an optical filter unit of FIG. 1.

As illustrated in FIGS. 1 and 2, a multi-band image photographing apparatus according to a first embodiment of the present disclosure may include a camera unit 100 acquiring multi-band images including visible light and infrared images, a lighting unit 200 emitting infrared light, an optical filter unit 300 including an infrared blocking filter area 312 and an infrared transmission filter area 314, a light adjustment controller 400 controlling the camera unit 100, the lighting unit 200, and the optical filter unit 300, and an image synthesis unit 500 synthesizing the multi-band images acquired by the camera unit 100.

The camera unit 100 may be a broadband camera acquiring a visible light image corresponding to a visible light wavelength band, an infrared image corresponding to an infrared wavelength band, and a broadband image corresponding to a broadband including the visible light wavelength band and the infrared wavelength band, but is not limited thereto.

The optical filter unit 300 may move and arrange the infrared blocking filter area 312 on an optical path to selectively transmit visible light or move and arrange the infrared transmission filter area 314 on the optical path to transmit infrared light.

For example, the optical filter unit 300 may include a light circulation filter that includes at least one infrared blocking filter area 312 and at least one infrared transmission filter area 314 and rotationally moves or linearly moves the infrared blocking filter area 312 or the infrared transmission filter area 314 onto the optical path.

In the light circulation filter, the infrared blocking filter area 312 and the infrared transmission filter area 314 may be alternately arranged with each other one by one, or the multiple infrared blocking filter areas 312 and the multiple infrared transmission filter areas 314 may be repeatedly arranged.

The light circulation filter may be a rotational circulation filter 310a that rotationally moves the infrared blocking filter area 312 or the infrared transmission filter area 314 onto the optical path.

In some cases, the light circulation filter may be a reciprocating circulation filter 310b that reciprocates the infrared blocking filter area 312 or the infrared transmission filter area 314 up and down or left and right onto the optical path.

In the light circulation filter, the infrared transmission filter area 314 may include glass through which light of all wavelength bands is transmitted, or include a visible light blocking filter blocking the visible light wavelength band.

The optical filter unit 300 configured as above may further include a driver 320 that drives the light circulation filter so that the infrared blocking filter area 312 or the infrared transmission filter area 314 of the light circulation filter moves onto the optical path in response to a control signal of the light adjustment controller 400.

For example, the driver 320 may be a motor that rotates the light circulation filter in response to the control signal of the light adjustment controller 400, but is not limited thereto.

Next, the light adjustment controller 400 may determine a light level based on an amount of infrared light of a photographing environment to control the lighting unit 200 so that infrared light corresponding to the determined light level is emitted, and control the optical filter unit 300 to move and arrange the infrared blocking filter area 312 or the infrared transmission filter area 314 on the optical path based on an optical wavelength band image to be acquired by the camera unit 100.

For example, the light adjustment controller 400 may include a light level adjustment unit 410 that determines a light level based on an amount of infrared light of the photographing environment and controls the lighting unit 200 so that infrared light corresponding to the determined light level is emitted, a camera controller 430 controlling a photographing timing of the camera unit 100, and an optical filter controller 440 that is synchronized with the photographing timing of the camera unit 100 and controls a drive of the optical filter unit 300.

In addition, the light adjustment controller 400 may further include an infrared illumination sensor 420 sensing the amount of infrared light of the photographing environment.

The light adjustment controller 400 may synchronize the camera unit 100 and the optical filter unit 300 based on an external trigger signal or a camera internal vertical synchronization signal.

The optical filter controller 440 may control a rotational speed or rotational step of the optical filter unit 300, or control a reciprocating speed of the optical filter unit 300.

FIG. 2(a) illustrates a drive of the optical filter unit in order for the camera unit 100 to acquire a broadband image including a visible light image and an infrared image including a wavelength band and an infrared wavelength band, and FIG. 2(b) illustrates a drive of the optical filter unit in order for the camera unit 100 to acquire a visible light image corresponding to a visible light wavelength band.

As illustrated in FIG. 2(a), when the light circulation filter of the optical filter unit 300 arranges the infrared transmission filter area 314 on the optical path to transmit visible light and infrared light, the camera unit 100 may take a broadband image including a visible light image and an infrared image.

When the infrared transmission filter area 314 of the light circulation filter includes glass through which light of all wavelength bands is transmitted, all light bands including visible light and infrared light are transmitted. Therefore, the camera unit 100 may take a broadband image including a visible light image and an infrared image.

When the infrared transmission filter area 314 of the light circulation filter includes the visible light blocking filter blocking the visible light wavelength band, the visible light band is blocked and the infrared band is transmitted. Therefore, the camera unit 100 may take an infrared image.

As illustrated in FIG. 2(b), when the light circulation filter of the optical filter unit 300 arranges the infrared blocking filter area 312 on the optical path to block infrared light and transmit visible light, the camera unit 100 may take a visible light image.

If the light circulation filter is the rotational circulation filter 310a, the rotational circulation filter 310a may rotationally move the infrared blocking filter area 312 or the infrared transmission filter area 314 onto the optical path and circularly arrange it.

In some cases, if the light circulation filter is the reciprocating circulation filter 310b, the reciprocating circulation filter 310b may reciprocate the infrared blocking filter area 312 or the infrared transmission filter area 314 up and down or left and right onto the optical path and circularly arrange it.

As above, in the first embodiment of the present disclosure, the rotational circulation filter (or a reciprocating circulation filter repeatedly circulating in one dimension), in which a film passing through the visible light band and the infrared band and the infrared blocking filter are intersected and connected to each other, may be disposed in front of the camera capable of photographing a broadband including a visible light band and a near-infrared band.

As illustrated in FIG. 2(a), in a first frame, it may pass through all broadbands (band of about 380 nm to 1500 nm), and visible light image+infrared (IR) image may be photographed.

In some cases, in the first frame, only the infrared (IR) image may be photographed using the visible light blocking filter.

Next, as illustrated in FIG. 2(b), in a second frame, an image of a visible light band (a band of about 380 nm to 780 nm) may be photographed in a state where the circulation filter places the infrared blocking filter on the optical path.

In this instance, the circulation filter can be both a rotational filter using a photographing synchronized motor and a reciprocating filter using an electromagnetic switch.

The circulation filter may be used such that division planes are connected by alternating two types of filters having 2 or more divisions so as to increase a frame rate at the same motor speed.

That is, the filter according to the present disclosure is not limited to 2 divisions and can be divided into multiple divisions.

In the first embodiment of the present disclosure, as illustrated in FIG. 1, the camera and the light circulation filter may be synchronized by the external trigger signal or the camera internal vertical synchronization signal.

Further, speed (rpm) and step timing of a motor (or a step motor) to operate the light circulation filter can be controlled in response to a photographing timing signal.

In case of the reciprocating filter, a reciprocating speed can be controlled.

In addition, an intensity of an infrared (IR) lamp fixed outside the camera may be adjusted based on the amount of infrared light of the photographing environment. On the other hand, a light level of the infrared lamp may be adjusted in inverse proportion to an amount of infrared light measured by the infrared illumination sensor.

For example, in a room where the amount of infrared light is small even if the lighting is strong, the infrared lamp must be bright.

In the first embodiment of the present disclosure, when the acquired visible light image and broadband image are synthesized, a dark shadow and a backlight area of the visible light image can be clear due to synthesis with the broadband image.

In particular, in a room where the indoor lighting is bright but the amount of infrared light is small, a shaded portion in the visible light image can be clearly expressed by using auxiliary light of the infrared lamp.

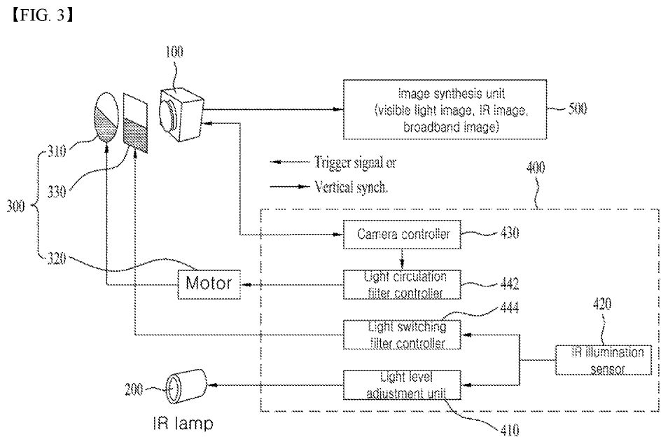

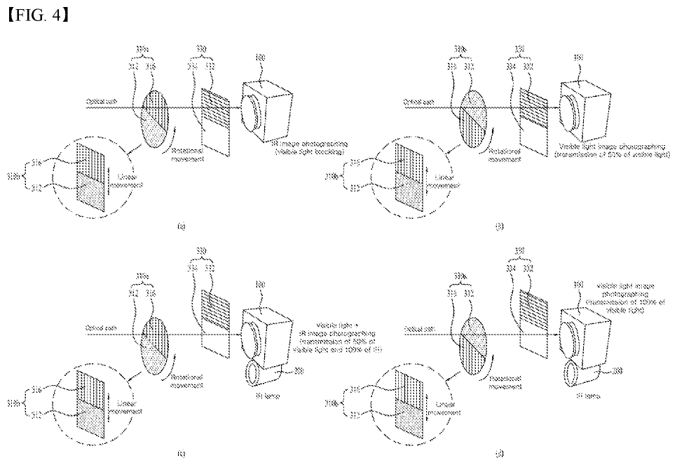

FIG. 3 is a block configuration diagram illustrating a multi-band image photographing apparatus according to a second embodiment of the present disclosure. FIG. 4 illustrates a drive of an optical filter unit of FIG. 3.

As illustrated in FIGS. 3 and 4, a multi-band image photographing apparatus according to a second embodiment of the present disclosure may include a camera unit 100 acquiring multi-band images including visible light and infrared images, a lighting unit 200 emitting infrared light, an optical filter unit 300 including an infrared blocking filter area 312 and an infrared transmission filter area 314, a light adjustment controller 400 controlling the camera unit 100, the lighting unit 200, and the optical filter unit 300, and an image synthesis unit 500 synthesizing the multi-band images acquired by the camera unit 100.

The camera unit 100 may be a broadband camera acquiring a visible light image corresponding to a visible light wavelength band, an infrared image corresponding to an infrared wavelength band, and a broadband image corresponding to a broadband including the visible light wavelength band and the infrared wavelength band, but is not limited thereto.

The optical filter unit 300 may move and arrange the infrared blocking filter area 312 on an optical path to selectively transmit visible light or move and arrange a visible light blocking filter area on the optical path to transmit infrared light.

For example, the optical filter unit 300 may include a light circulation filter 310 including at least one infrared blocking filter area 312 and at least one first polarization filter area 316, and a light switching filter 330 including at least one second polarization filter area 332 and at least one light transmission area 334.

The light circulation filter 310 may rotationally move or linearly move the infrared blocking filter area 312 or the first polarization filter area 316 onto the optical path.

Further, the light switching filter 330 may linearly move the second polarization filter area 332 or the light transmission area 334 onto the optical path.

In the optical filter unit 300, the first polarization filter area 316 of the light circulation filter 310 may be a vertical visible light polarization filter, and the second polarization filter area 332 of the light switching filter 330 may be a horizontal visible light polarization filter.

In some cases, in the optical filter unit 300, the first polarization filter area 316 of the light circulation filter 310 may be a horizontal visible light polarization filter, and the second polarization filter area 332 of the light switching filter 330 may be a vertical visible light polarization filter.

In the light circulation filter 310, the infrared blocking filter areas 312 and the first polarization filter areas 316 may be alternately arranged one by one, or the multiple infrared blocking filter areas 312 and the multiple first polarization filter areas 316 may be repeatedly arranged.

The light circulation filter 310 may be a rotational circulation filter 310a that rotationally moves the infrared blocking filter area 312 or the first polarization filter area 316 onto the optical path.

In some cases, the light circulation filter 310 may be a reciprocating circulation filter 310b that reciprocates the infrared blocking filter area 312 or the first polarization filter area 316 up and down or left and right onto the optical path.

The light circulation filter 310 may construct the first polarization filter area 316 using a vertical visible light filter or a horizontal visible light filter based on the second polarization filter area 332 of the light switching filter 330.

Next, in the light switching filter 330, the second polarization filter areas 332 and the light transmission areas 334 may be alternately arranged one by one, or the multiple second polarization filter areas 332 and the multiple light transmission areas 334 may be repeatedly arranged.

The light switching filter 330 may be a reciprocating circulation filter that reciprocates the second polarization filter area 332 or the light transmission area 334 up and down or left and right onto the optical path.

The light switching filter 330 may construct the second polarization filter area 332 using a vertical visible light filter or a horizontal visible light filter based on the first polarization filter area 316 of the light circulation filter 310.

The light switching filter 330 may construct the light transmission area 334 using glass through which light of all wavelength bands is transmitted, but is not limited thereto.

The optical filter unit 300 may further include a driver 320 that drives the light circulation filter 310 so that the infrared blocking filter area 312 or the first polarization filter area 316 of the light circulation filter 310 moves onto the optical path in response to a control signal of the light adjustment controller 400.

For example, the driver 320 may be a motor that rotates the light circulation filter 310 in response to the control signal of the light adjustment controller 400, but is not limited thereto.

In some cases, the driver 320 may design a circuit configuration for driving each of the light circulation filter 310 and the light switching filter 330, but is not limited thereto.

Next, the light adjustment controller 400 may include a light level adjustment unit 410 that determines a light level based on an amount of infrared light of a photographing environment and controls the lighting unit 200 so that infrared light corresponding to the determined light level is emitted, a camera controller 430 controlling a photographing timing of the camera unit 100, a light circulation filter controller 442 that is synchronized with the photographing timing of the camera unit 100 and controls a drive of the light circulation filter 310 of the optical filter unit 300, and a light switching filter controller 444 that controls a drive of the light switching filter 330 of the optical filter unit 300 based on the amount of infrared light of the photographing environment.

The light adjustment controller 400 may further include an infrared illumination sensor 420 sensing the amount of infrared light of the photographing environment.

The light adjustment controller 400 may synchronize the camera unit 100 and the optical filter unit 300 based on an external trigger signal or a camera internal vertical synchronization signal.

The light circulation filter controller 442 may control a rotational speed or rotational step of the light circulation filter 310 of the optical filter unit 300 or control a reciprocating speed of the optical filter unit 300.

The light switching filter controller 444 may control a vertical or horizontal reciprocating speed of the light switching filter 330 of the optical filter unit 300.

For example, in a day mode, the light switching filter controller 444 may control the optical filter unit 300 so that the second polarization filter area 332 of the light switching filter 330 moves onto the optical path.

Further, in a night mode, the light switching filter controller 444 may control the optical filter unit 300 so that the light transmission area 334 of the light switching filter 330 moves onto the optical path.

As described above, the second embodiment of the present disclosure is a device capable of selectively photographing two-band images during the day and night for three band sections: broadband, visible light, and infrared light.

FIG. 4(a) illustrates a process of photographing an infrared image in a day mode, FIG. 4(b) illustrates a process of photographing a visible light image when visible light is transmitted about 50% in the day mode, FIG. 4(c) illustrates a process of photographing a broadband (infrared light+visible light) image when visible light is transmitted about 50% and infrared light is transmitted about 100% in a night mode, and FIG. 4(d) illustrates a process of photographing a visible light image when visible light is transmitted about 100% in the night mode.

Here, a light adjustment filter may include a light circulation (rotational circulation or reciprocating circulation) filter 310 as a first-order filter and a light switching filter 330 as a second-order filter. The light circulation filter 310 may be used for cross-band photographing, and the light switching filter 330 may be used for switching between day photographing and night photographing.

First, in the day mode, as illustrated in FIGS. 4(a) and 4(b), the light circulation filter 310 as the first-order filter is configured such that a vertical (as opposed to the light switching filter) visible light polarization filter and an infrared blocking filter are alternately positioned per photographing frame on an optical path, and the light switching filter 330 as the second-order filter is configured such that a horizontal (as opposed to the light circulation filter) visible light polarization filter is fixed on the optical path.

Here, the visible light polarization filter is characterized in that it operates to polarize only a visible light band (only S or P waves are transmitted) and transmit an infrared band without attenuation.

As illustrated in FIG. 4(a), as external light passes through the vertical and horizontal visible light polarization filters, visible light is blocked and an infrared image is photographed.

In this instance, the vertical and horizontal visible light polarization filters may also serve as a visible light blocking filter.

As illustrated in FIG. 4(b), as external light passes through the infrared blocking filter and the horizontal visible light polarization filter, the infrared band is blocked, and a visible light image attenuated by about 50% is photographed.

This has the effect of adjusting a brightness balance with the infrared image at an appropriate exposure by reducing visible light energy with a relatively high saturation during the day.

Next, in the night mode, as illustrated in FIGS. 4(c) and 4(d), the light switching filter 330 as the second-order filter on the optical path is configured such that a polarization filter is removed and all bands are passed, and a multi-photographing is performed alternately according to the order of frames by the light circulation filter 310 as the first-order filter.

In this instance, unlike the day mode, visible light images and broadband images without a reduction in the amount of light are photographed considering relatively weak lighting conditions.

In the broadband image, visible light is attenuated by about 50% so as to mitigate infrared image interference from lighting, etc., and infrared light is transmitted about 100%. Hence, it is possible to maintain the brightness balance of the visible light image and the broadband image at an appropriate exposure.

However, in the day mode and the night mode, a rotational circulation filter 310a may be used such that division planes are connected by alternating two types of filters having 2 or more divisions so as to increase a frame rate at the same motor speed.

That is, the filter according to the present disclosure is not limited to 2 divisions and can be divided into multiple divisions.

In the second embodiment of the present disclosure, as illustrated in FIG. 3, the optical filter unit 300 including the light circulation filter 310 as the first-order filter and the light switching filter 330 as the second-order filter and the light switching filter controller 444 by the infrared illumination sensor 420 are added, compared to the first embodiment of the present disclosure.

The light switching filter 330 may control the filter switching between the day and the night based on an illumination amount of infrared light.

The filter switching may be based on the illumination amount of infrared light. When the illumination amount of infrared light is greater than or equal to an appropriate level, the filter switching may switch to the day mode, and when the illumination amount of infrared light is less than or equal to the appropriate level, the filter switching may switch to the night mode.

In the second embodiment of the present disclosure, first, the camera unit 100 and the light circulation filter 310 may be synchronized by the external trigger signal or the camera internal vertical synchronization signal.

Next, speed (rpm) and step timing of a motor (or a step motor) to operate the light circulation filter 310 can be controlled in response to a photographing timing signal.

In case of the reciprocating filter, a reciprocating speed can be controlled.

In addition, an intensity of an infrared (IR) lamp fixed outside the camera may be adjusted based on the amount of infrared light of the photographing environment. On the other hand, a light level of the infrared lamp may be adjusted in inverse proportion to an amount of infrared light measured by the infrared illumination sensor.

For example, in a room where the amount of infrared light is small even if the lighting is strong, the infrared lamp must be bright.

As above, in the case of cross photographing of two bands, exclusive band photographing without mutual interference is most advantageous for information synthesis.

That is, independent band photographing and synthesis of visible and near-infrared bands can provide the most efficient image results.

In the first embodiment of the present disclosure, a dark area of visible light can be improved from synthesis with the broadband image, but a bright saturated area of the visible light image is inevitably saturated even in the broadband image.

However, as in the second embodiment of the present disclosure, the first embodiment can be improved by using the visible light blocking filter instead of the filter passing through the broadband.

For example, if a daytime image is photographed by separating the visible light band and the infrared band, the infrared image for a saturated area of the visible light image may include detailed information. Therefore, in a synthesized image thereof, the saturated area of the visible light image can also be clearly photographed.

However, photographing with visible light blocking is effective during the day. However, if visible light is blocked during the night, the brightness of an infrared image depending on infrared lamp auxiliary light may be excessively reduced, and severe noise distortion may occur in a process of increasing the brightness of the infrared image by an average exposure compensation of the camera.

Accordingly, as in the second embodiment of the present disclosure, when a broadband pass filter instead of the visible light blocking filter is used for a nighttime image, and infrared lamp auxiliary light is irradiated for the nighttime image, a clear nighttime broadband image or a clear nighttime visible light image can be photographed.

That is, infrared image photographing with visible light blocking is required during the day, and broadband image photographing is required during the night.

As described above, the present disclosure can easily and simply acquire a multi-band image including a visible light image, an infrared image, and a broadband image by using one general image sensor and one circulation filter or using one general image sensor and a composite filter including a circulation filter and a switching filter, and can implement image synthesis capable of visually identifying and recognizing objects in various lighting environments.

A multi-band image photographing apparatus according to the present disclosure including a camera unit, a lighting unit, an optical filter unit, a light adjustment controller, and an image synthesis unit can photograph a multi-band image as follows.

First, the light adjustment controller according to the present disclosure may check whether an image photographing request is received, and check an amount of infrared light of a photographing environment if the image photographing request is received.

The light adjustment controller according to the present disclosure may determine whether to emit infrared light based on the amount of infrared light of the photographing environment.

Next, the lighting unit according to the present disclosure may emit infrared light based on a determined light level.

The optical filter unit according to the present disclosure may circularly arrange an infrared blocking filter area or an infrared transmission filter area on an optical path.

When circularly arranging the infrared blocking filter area or the infrared transmission filter area on the optical path, the optical filter unit according to the present disclosure can block infrared light and transmit visible light by arranging an infrared blocking filter area of a light circulation filter on the optical path, or can transmit visible light and infrared light by arranging an infrared transmission filter area of the light circulation filter on the optical path.

In some cases, when circularly arranging the infrared blocking filter area or the infrared transmission filter area on the optical path, the optical filter unit according to the present disclosure can block visible light and transmit infrared light by arranging a first polarization filter area of a light circulation filter and a second polarization filter area of a light switching filter on the optical path, or can block infrared light and transmit 50% of visible light by arranging an infrared blocking filter area of the light circulation filter and the second polarization filter area of the light switching filter on the optical path, or can transmit 50% of visible light and 100% of infrared light by arranging the first polarization filter area of the light circulation filter and a light transmission area of the light switching filter on the optical path, or can block infrared light and transmit 100% of visible light by arranging the infrared blocking filter area of the light circulation filter and the light transmission area of the light switching filter on the optical path.

The camera unit according to the present disclosure can acquire a visible light image corresponding to a visible light wavelength band if the infrared blocking filter area of the optical filter unit is disposed in front, and can acquire an infrared image corresponding to an infrared wavelength band or a broadband image corresponding to a broadband including the visible light wavelength band and the infrared wavelength band if the infrared transmission filter area of the optical filter unit is disposed in front.

The image synthesis unit according to the present disclosure can synthesize at least two images based on the acquired visible light image, infrared image, and broadband image.

The features, structures, effects, etc. of the present disclosure described above are included in at least one embodiment of the present disclosure, and are not necessarily limited to only one embodiment. Furthermore, the features, structures, effects, etc. illustrated in each embodiment can be combined or modified for other embodiments by those skilled in the art to which embodiments pertain. Accordingly, the contents related to these combinations and modifications should be interpreted as being included in the scope of the present disclosure.

It is apparent to those skilled in the art that the present disclosure can be embodied in other specific forms without departing from the spirit and essential features of the present disclosure. Accordingly, the aforementioned detailed description should not be construed as limiting in all aspects and should be considered as illustrative. The scope of the present disclosure should be determined by rational interpretation of the appended claims, and all modifications within an equivalent scope of the present disclosure are included in the scope of the present disclosure.

### DESCRIPTION OF REFERENCE NUMERALS

100: camera unit
200: lighting unit
300: optical filter unit
400: light adjustment controller
500: image synthesis unit

1. A multi-band image photographing apparatus comprising:
a camera unit configured to acquire multi-band images including a visible light image and an infrared image;
a lighting unit configured to emit infrared light;
an optical filter unit including an infrared blocking filter area and an infrared transmission filter area, the optical filter unit being configured to selectively transmit visible light by moving and arranging the infrared blocking filter area on an optical path or transmit the infrared light by moving and arranging the infrared transmission filter area on the optical path; and
a light adjustment controller configured to control the camera unit, the lighting unit, and the optical filter unit,
wherein the light adjustment controller is configured to:
determine a light level based on an amount of infrared light of a photographing environment and control the lighting unit so that the infrared light corresponding to the determined light level is emitted; and
control the optical filter unit to move and arrange the infrared blocking filter area or the infrared transmission filter area on the optical path based on an optical wavelength band image to be acquired by the camera unit.

2. The multi-band image photographing apparatus of claim 1, further comprising:
an image synthesis unit configured to synthesize the multi-band images acquired by the camera unit.

3. The multi-band image photographing apparatus of claim 1, wherein the camera unit includes a broadband camera acquiring a visible light image corresponding to a visible light wavelength band, an infrared image corresponding to an infrared wavelength band, and a broadband image corresponding to a broadband including the visible light wavelength band and the infrared wavelength band.

4. The multi-band image photographing apparatus of claim 1, wherein the optical filter unit includes a light circulation filter that includes at least one infrared blocking filter area and at least one infrared transmission filter area and rotationally moves or linearly moves the infrared blocking filter area or the infrared transmission filter area onto the optical path.

5. The multi-band image photographing apparatus of claim 4, wherein the light circulation filter is configured such that the infrared blocking filter area and the infrared transmission filter area are alternately arranged with each other.

6. The multi-band image photographing apparatus of claim 4, wherein the light circulation filter is a rotational circulation filter that rotationally moves the infrared blocking filter area or the infrared transmission filter area onto the optical path.

7. The multi-band image photographing apparatus of claim 4, wherein the light circulation filter is a reciprocating circulation filter that reciprocates the infrared blocking filter area or the infrared transmission filter area up and down or left and right onto the optical path.

8. The multi-band image photographing apparatus of claim 4, wherein the infrared transmission filter area of the light circulation filter includes glass through which light of all wavelength bands is transmitted, or includes a visible light blocking filter blocking the visible light wavelength band.

9. The multi-band image photographing apparatus of claim 4, wherein the optical filter unit further includes a driver that drives the light circulation filter so that the infrared blocking filter area or the infrared transmission filter area of the light circulation filter moves onto the optical path in response to a control signal of the light adjustment controller.

10. The multi-band image photographing apparatus of claim 9, wherein the driver is a motor that rotates the light circulation filter in response to the control signal of the light adjustment controller.

11. The multi-band image photographing apparatus of claim 1, wherein the optical filter unit includes:
a light circulation filter including at least one infrared blocking filter area and at least one first polarization filter area, the light circulation filter rotationally moving or linearly moving the infrared blocking filter area or the first polarization filter area onto the optical path; and
a light switching filter including at least one second polarization filter area and at least one light transmission area, the light switching filter linearly moving the second polarization filter area or the light transmission area onto the optical path.

12. The multi-band image photographing apparatus of claim 11, wherein in the optical filter unit,
the first polarization filter area of the light circulation filter is a vertical visible light polarization filter, and the second polarization filter area of the light switching filter is a horizontal visible light polarization filter, or
the first polarization filter area of the light circulation filter is a horizontal visible light polarization filter, and the second polarization filter area of the light switching filter is a vertical visible light polarization filter.

13. The multi-band image photographing apparatus of claim 1, wherein the light adjustment controller includes:
a light level adjustment unit configured to determine the light level based on the amount of infrared light of the photographing environment and control the lighting unit so that the infrared light corresponding to the determined light level is emitted;
a camera controller configured to control a photographing timing of the camera unit; and
an optical filter controller synchronized with the photographing timing of the camera unit and configured to control a drive of the optical filter unit.

14. The multi-band image photographing apparatus of claim 13, wherein the light adjustment controller further includes an infrared illumination sensor configured to sense the amount of infrared light of the photographing environment.

15. The multi-band image photographing apparatus of claim 13, wherein the light adjustment controller synchronizes the camera unit and the optical filter unit based on an external trigger signal or a camera internal vertical synchronization signal.

16. The multi-band image photographing apparatus of claim 13, wherein the optical filter controller controls a rotational speed or rotational step of the optical filter unit or controls a reciprocating speed of the optical filter unit.

17. The multi-band image photographing apparatus of claim 1, wherein the light adjustment controller includes:
a light level adjustment unit configured to determine the light level based on the amount of infrared light of the photographing environment and control the lighting unit so that the infrared light corresponding to the determined light level is emitted;
a camera controller configured to control a photographing timing of the camera unit;
a light circulation filter controller synchronized with the photographing timing of the camera unit and configured to control a drive of a light circulation filter of the optical filter unit; and
a light switching filter controller configured to control a drive of a light switching filter of the optical filter unit based on the amount of infrared light of the photographing environment.

18. The multi-band image photographing apparatus of claim 17, wherein the light adjustment controller further includes an infrared illumination sensor configured to sense the amount of infrared light of the photographing environment.

19. The multi-band image photographing apparatus of claim 17, wherein the light adjustment controller synchronizes the camera unit and the optical filter unit based on an external trigger signal or a camera internal vertical synchronization signal.

20. The multi-band image photographing apparatus of claim 17, wherein the light circulation filter controller controls a rotational speed or rotational step of the light circulation filter of the optical filter unit or controls a reciprocating speed of the optical filter unit.

21. The multi-band image photographing apparatus of claim 17, wherein the light switching filter controller controls a vertical or horizontal reciprocating speed of the light switching filter of the optical filter unit.

22. A multi-band image photographing method of a multi-band image photographing apparatus including a camera unit, a lighting unit, an optical filter unit, a light adjustment controller, and an image synthesis unit, the multi-band image photographing method comprising:
checking, by the light adjustment controller, whether an image photographing request is received;
checking, by the light adjustment controller, an amount of infrared light of a photographing environment if the image photographing request is received;
determining, by the light adjustment controller, a light level based on the amount of infrared light of the photographing environment and determining whether to emit the infrared light corresponding to the determined light level;
emitting, by the lighting unit, the infrared light based on the determined light level;
circularly arranging, by the optical filter unit, an infrared blocking filter area or an infrared transmission filter area on an optical path;
acquiring, by the camera unit, a visible light image corresponding to a visible light wavelength band if the infrared blocking filter area of the optical filter unit is disposed in front, and acquiring an infrared image corresponding to an infrared wavelength band or a broadband image corresponding to a broadband including the visible light wavelength band and the infrared wavelength band if the infrared transmission filter area of the optical filter unit is disposed in front; and
synthesizing, by the image synthesis unit, at least two images based on the acquired visible light image, infrared image, and broadband image.

23. The multi-band image photographing method of claim 22, wherein circularly arranging the infrared blocking filter area or the infrared transmission filter area on the optical path comprises, if the optical filter unit includes a light circulation filter,
arranging an infrared blocking filter area of the light circulation filter on the optical path to block the infrared light and transmit visible light, or
arranging an infrared transmission filter area of the light circulation filter on the optical path to transmit the visible light and the infrared light.

24. The multi-band image photographing method of claim 22, wherein circularly arranging the infrared blocking filter area or the infrared transmission filter area on the optical path comprises, if the optical filter unit includes a light circulation filter and a light switching filter,
arranging a first polarization filter area of the light circulation filter and a second polarization filter area of the light switching filter on the optical path to block visible light and transmit the infrared light, or
arranging an infrared blocking filter area of the light circulation filter and the second polarization filter area of the light switching filter on the optical path to block the infrared light and transmit 50% of the visible light, or
arranging the first polarization filter area of the light circulation filter and a light transmission area of the light switching filter on the optical path to transmit 50% of the visible light and 100% of the infrared light, or
arranging the infrared blocking filter area of the light circulation filter and the light transmission area of the light switching filter on the optical path to block the infrared light and transmit 100% of the visible light.
